(19) United States
(12) Patent Application Publication
(10) Pub. No.: US 2026/0132066 A1
(43) Pub. Date: May 14, 2026

(54) SEMICONDUCTOR PROCESS WASTEWATER TREATMENT SYSTEM TO WHICH ADVANCED OXIDATION PROCESS AND ANAEROBIC BIOLOGICAL PROCESS ARE APPLIED AND SEMICONDUCTOR PROCESS WASTEWATER TREATMENT METHOD USING THE SAME

(71) Applicants: SK hynix Inc., Icheon-si (KR); Korea University Research and Business Foundation, Sejong Campus, Sejong-si (KR)

(72) Inventors: Gwangil JANG, Icheon-si (KR); Sunmin KIM, Icheon-si (KR); Sehyuk AHN, Icheon-si (KR); Young-jin KIM, Sejong-si (KR); Song-bok LEE, Sejong-si (KR); Dong-uk CHOI, Sejong-si (KR)

(21) Appl. No.: 19/278,105

(22) Filed: Jul. 23, 2025

(30) Foreign Application Priority Data
Jul. 24, 2024 (KR) 10-2024-0097810

(51) Int. Cl. C02F 9/00; B01D 61/46; C02F 1/20; C02F 1/469; C02F 1/66; C02F 1/72; C02F 3/28; C02F 101/10; C02F 101/16; C02F 101/38; C02F 103/34

(52) U.S. Cl. CPC C02F 9/00; B01D 61/463; C02F 1/20; C02F 1/4693; C02F 1/66; C02F 1/722; C02F 3/2853; C02F 2101/101; C02F 2101/16; C02F 2101/38; C02F 2103/346; C02F 2201/3222; C02F 2201/328; C02F 2303/18

(57) ABSTRACT

A semiconductor process wastewater treatment system and a method for treating semiconductor process wastewater using the system are disclosed. The disclosed semiconductor process wastewater treatment system comprises: an advanced oxidation reaction tank for advanced oxidation of a semiconductor process wastewater comprising tetramethyl ammonium hydroxide (TMAH) using a UV/PDS process that activates peroxydisulfate (PDS) with ultraviolet light (UV ray); an anaerobic biological reaction tank for biologically treating the semiconductor process wastewater that has passed through the advanced oxidation reactor, the anaerobic biological reaction tank configured to treat the semiconductor process wastewater with microorganisms comprising sulfate reducing bacteria (SRB) under anaerobic conditions, and configured to react sulfate generated in the advanced oxidation reactor with the sulfate reducing bacteria to generate H₂S; and a gas separator for separating the H₂S from gas generated in the anaerobic biological reactor.

### CROSS-REFERENCES TO RELATED APPLICATION

The present application claims, under 35 U.S.C. § 119 (a), the benefit of Korean Patent Application No. 10-2024-0097810, filed on Jul. 24, 2024 which is hereby incorporated by reference in its entirety.

### BACKGROUND

### 1. Field

The present disclosure relates to a wastewater treatment system and a wastewater treatment method, and more particularly to a semiconductor process wastewater treatment system and a semiconductor process wastewater treatment method using the same.

### 2. Description of the Related Art

During semiconductor manufacturing, each process generates a significant amount of wastewater. Semiconductor process wastewater contains high concentrations of toxic substances, and efficient removal of these substances is required. In recent years, there has been a growing interest in semiconductor process wastewater treatment and a lot of research has been conducted in this area.

During the semiconductor manufacturing process, wastewater containing high concentrations of tetramethyl ammonium hydroxide (TMAH) may be generated. TMAH is a strongly basic organic substance that may be used as an etchant for silicon in the semiconductor manufacturing process, and is highly toxic and highly soluble in water. As products become more sophisticated, the amount of TMAH used is increasing, and there is a need to develop methods and facilities that may reliably treat the increased amount of TMAH wastewater. Wastewater containing TMAH may be treated through biological treatment processes, but due to the high toxicity of TMAH, the TMAH can kill microbes used in the biological treatment processes, thereby inhibiting those processes or preventing them from occurring. In addition, conventional wastewater treatment processes suffer from low treatment efficiency, high chemical input, low economic efficiency, and high environmental burden.

Therefore, in the treatment of wastewater containing recalcitrant organics such as TMAH, it is helpful to develop technologies that may secure process stability, increase treatment efficiency, reduce treatment costs, collection/recycle resources, and reduce environmental impact.

### SUMMARY

An objective of the present disclosure is to provide a semiconductor process wastewater treatment system and a method for treating semiconductor process wastewater using the system that may secure process stability and increase treatment efficiency (process efficiency) in the treatment of semiconductor process wastewater containing recalcitrant organics such as TMAH.

Furthermore, an objective of the present disclosure is to provide a semiconductor process wastewater treatment system and a method for treating semiconductor process wastewater using the system that may not only reduce treatment costs, but also improve economic efficiency and reduce environmental impact/burden through resource collecting and recycling, etc. in the treatment of semiconductor process wastewater containing recalcitrant organic matter such as TMAH.

It should be understood that the objectives of the present disclosure are not limited to the objectives mentioned above, and additional objectives will be apparent to those skilled in art from the following detailed description.

According to one embodiment of the present disclosure, a semiconductor process wastewater treatment system includes an advanced oxidation reactor configured to oxidize semiconductor process wastewater comprising tetramethyl ammonium hydroxide (TMAH) using a UV/PDS process that activates peroxydisulfate (PDS) with ultraviolet light (UV ray); an anaerobic biological reactor configured to biologically treat the semiconductor process wastewater that has passed through the advanced oxidation reactor with microorganisms comprising sulfate reducing bacteria (SRB) under anaerobic conditions, and configured to react sulfate generated in the advanced oxidation reactor with the sulfate reducing bacteria to generate H₂S, and there is provided a semiconductor process wastewater treatment system comprising a gas separator configured to separate the H₂S from gas generated in the anaerobic biological reactor.

The anaerobic biological reactor may be an anaerobic membrane bioreactor (AnMBR).

The semiconductor process wastewater treatment system may further comprise an ammonia collector configured to collect ammonia from effluent discharged from the anaerobic biological reactor.

The advanced oxidation reactor may comprise a plurality of ultraviolet light emitters, wherein each of the plurality of ultraviolet light emitters may comprise at least one UV-LED device, wherein the plurality of ultraviolet light emitters may be arranged to provide a plurality of bends in a meandering wastewater travel path, such that the semiconductor process wastewater flows along the meandering wastewater travel path.

The advanced oxidation reactor may include an impeller structure, and the impeller structure may include a rotating shaft member and a helical blade member coupled to the rotating shaft member, and UV-LED elements may be coupled to the helical blade member.

The advanced oxidation reactor may comprise an impeller structure, the impeller structure comprising a rotating shaft member and a plurality of blade members coupled to the rotating shaft member and mutually spaced apart along a longitudinal direction of the rotating shaft member, and UV-LED elements may be coupled to each of the plurality of blade members.

The semiconductor process wastewater treatment system may further comprise a pH adjustment portion configured to adjust the pH of the semiconductor process wastewater fed from the highly oxidizing reactor to the anaerobic biological reactor.

The semiconductor process wastewater treatment system may further comprise a bipolar electrodialysis (BPED) device configured to separate ions from effluent discharged from the anaerobic biological reactor.

The BPED device may be configured to produce at least one of H₂SO₄ and NH₄OH from the effluent.

The semiconductor process wastewater treatment system may further comprise a pH adjustment section configured to adjust the pH of the semiconductor process wastewater fed from the highly oxidizing reactor to the anaerobic biological reactor, and the semiconductor process wastewater treatment system may be configured to feed at least a portion of the H₂SO₄ generated by the BPED device to the pH adjustment section.

The BPED device may include a first region, a second region, a third region, a fourth region, and a fifth region, wherein the first region may be disposed between the second region and the third region, the second region may be disposed between the first region and the fourth region, and the third region may be disposed between the first region and the fifth region. A first cation separator may be disposed between the first region and the second region, a first anion separator may be disposed between the first region and the third region, a second anion separator and a second cation separator may be disposed between the second region and the fourth region, a third cation separator and a third anion separator may be disposed between the third region and the fifth region, and a third cation separator and a third anion separator may be disposed between the third region and the fifth region. In the second region, the H₂SO₄ may be produced, and in the third region, the NH₄OH may be produced.

The semiconductor process wastewater treatment system may further comprise an ammonia collector connected to the BPED unit.

The pH of the semiconductor process wastewater entering the advanced oxidation reactor may be in the range of about 11 to 13.

The pH of the semiconductor process wastewater entering the anaerobic biological reactor may be in the range of about 6 to 8.

According to another embodiment of the present disclosure, a method of treating semiconductor process wastewater is provided for treating semiconductor process wastewater comprising tetramethyl ammonium hydroxide (TMAH) using the aforementioned semiconductor process wastewater treatment system.

According to embodiments of the present disclosure, a semiconductor process wastewater treatment system and a method for treating semiconductor process wastewater using the system may be implemented that may secure process stability and increase treatment efficiency (process efficiency) in the treatment of semiconductor process wastewater containing recalcitrant organics such as TMAH. In addition, according to embodiments of the present disclosure, a semiconductor process wastewater treatment system and a semiconductor process wastewater treatment method using the system may be implemented that may not only reduce treatment costs in the treatment of semiconductor process wastewater containing recalcitrant organics such as TMAH, but also improve economic efficiency and reduce environmental impact/burden through resource collect and recycling.

According to one embodiment, by applying a combination of an advanced oxidation process and an anaerobic biological process, the stability of the wastewater treatment process may be easily achieved at a relatively low cost. Furthermore, according to one embodiment, by applying advanced oxidation prior to the anaerobic biological process, using a UV/PDS process that activates peroxydisulfate (PDS) with ultraviolet light (UV rays), the stability of the biological process may be significantly improved and cost savings may be achieved. Furthermore, in one embodiment, the anaerobic biological process utilizes sulfate reducing bacteria (SRB) to generate H₂S and collect it through gas separation, while collecting/recycling ammonia or other resource materials, thereby increasing economic efficiency and reducing environmental impact/burden. Furthermore, according to one embodiment, the efficiency of the advanced oxidation process may be significantly increased through the design technology of an advanced oxidation reactor, and the recyclability of resources may be further improved through bipolar electrodialysis.

However, the effects of the present disclosure are not limited to the effects described above, and may be extended in various ways without departing from the spirit and scope of the present disclosure.

### BRIEF DESCRIPTION OF THE DRAWINGS

FIG. 1 illustrates a semiconductor process wastewater treatment system according to an embodiment of the present disclosure.

FIG. 2 illustrates a semiconductor process wastewater treatment system according to another embodiment of the present disclosure.

FIG. 3 illustrates a semiconductor process wastewater treatment system according to another embodiment of the present disclosure.

FIG. 4 illustrates a semiconductor process wastewater treatment system according to another embodiment of the present disclosure.

FIG. 5 is a drawing exemplifying and partially illustrating a specific configuration of an impeller structure that may be adapted to the embodiment of FIG. 4.

FIG. 6 illustrates a semiconductor process wastewater treatment system according to another embodiment of the present disclosure.

FIG. 7 illustrates a semiconductor process wastewater treatment system according to another embodiment of the present disclosure.

FIG. 8 is a flowchart that illustrates a method for treating semiconductor process wastewater using a semiconductor process wastewater treatment system according to one embodiment of the present disclosure.

FIG. 9 is a flowchart that illustrates a method for treating semiconductor process wastewater using a semiconductor process wastewater treatment system according to another embodiment of the present disclosure.

FIG. 10 is a graph showing the results of treating wastewater containing TMAH using an advanced oxidation process that may be applied to a semiconductor process wastewater treatment system according to embodiments of the present disclosure.

### DETAILED DESCRIPTION

Embodiments of the present disclosure will now be described in detail with reference to the accompanying drawings.

The embodiments of the disclosure described below are provided for the purpose of more clearly illustrating the disclosure to those having ordinary skill in the art, and the scope of the disclosure is not intended to be limited by the following embodiments, which may be modified in various other ways.

The terms used in this specification are intended to describe specific embodiments and are not intended to limit the disclosure. Terms used herein in the singular form may include the plural form, unless the context clearly indicates otherwise. Furthermore, the terms “comprise” and/or “comprising” as used herein are intended to specify the presence of the mentioned shapes, steps, numbers, motions, elements, elements and/or groups thereof and are not intended to exclude the presence or addition of one or more other shapes, steps, numbers, motions, elements, elements and/or groups thereof. Furthermore, as used herein, the term “connected” is intended to mean not only that certain elements are directly connected, but also that they are indirectly connected by the interposition of other elements between them.

Further, when the present disclosure refers to a member being located “on” another member, this includes not only when a member is abutting another member, but also when there is another member between the two members. As used herein, the term “and/or” includes any one of the enumerated items and any combination of one or more of them. In addition, the terms “about,” “substantially,” and the like as used in the disclosure are intended to mean at or near the range of numbers or degrees, taking into account inherent manufacturing and material tolerances, and to prevent infringers from taking unfair advantage of the disclosure where precise or absolute numbers are stated, which are provided for the purpose of illustration.

Embodiments of the present disclosure will now be described in detail with reference to the accompanying drawings. The sizes or thicknesses of the areas or parts shown in the accompanying drawings may be somewhat exaggerated for clarity and ease of description. Throughout the detailed description, like reference numerals designate like components.

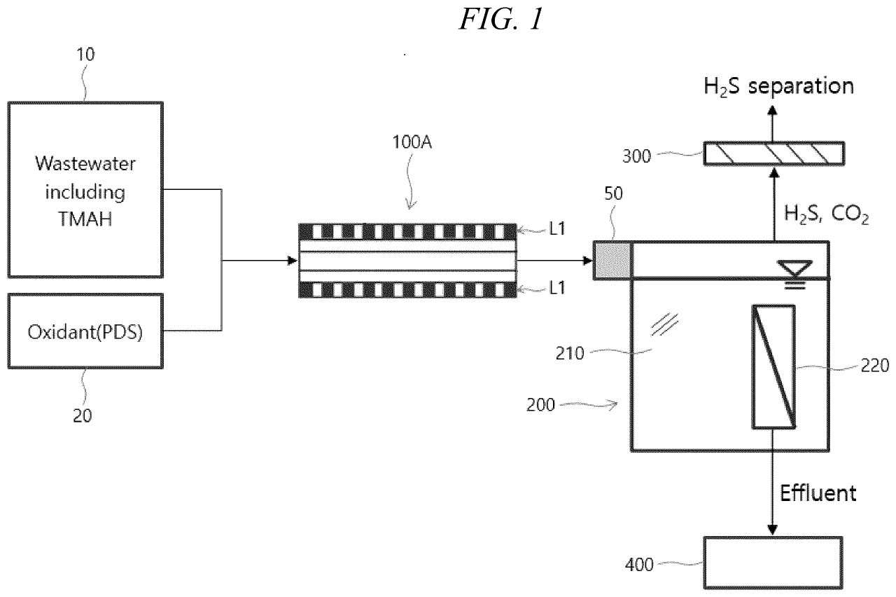

FIG. 1 illustrates a semiconductor process wastewater treatment system according to one embodiment of the present disclosure.

Referring to FIG. 1, a semiconductor process wastewater treatment system according to one embodiment of the present disclosure may be a system for treating semiconductor process wastewater including tetramethyl ammonium hydroxide (TMAH). TMAH is a strongly basic organic substance and a type of recalcitrant organic substance.

The semiconductor process wastewater treatment system may comprise an advanced oxidation reactor (100A) for advanced oxidation of the semiconductor process wastewater including TMAH using a UV/PDS process that activates peroxydisulfate (PDS) (i.e., S₂ O₈²⁻) with ultraviolet light (UV rays). The advanced oxidation reactor (100A) may be a highly oxidizing reactor that is configured to provide a high level of oxidation. The semiconductor process wastewater treatment system may include an anaerobic biological reactor (200) for biologically treating the semiconductor process wastewater after passing through the advanced oxidation reactor (100A). The anaerobic biological reactor (200) may be configured to treat the semiconductor process wastewater with microorganisms including sulfate reducing bacteria (SRB) under anaerobic conditions. The anaerobic biological reactor (200) may be configured to react sulfate generated in the advanced oxidation reactor (100A) with the sulfate reducing bacteria (SRB) to generate H₂S. In addition, the residual TMAH may be removed by biological reaction in the anaerobic biological reactor (200). In addition, the semiconductor process wastewater treatment system may include a gas separator (300) for separating the H₂S from the gas generated in the anaerobic biological reactor (200).

According to one embodiment, the semiconductor process wastewater treatment system may further include an ammonia collector (400) for collecting ammonia (NH₃) from the effluent discharged from the anaerobic biological reactor (200).

The semiconductor process wastewater treatment system may further include a wastewater supply portion (10) for supplying the semiconductor process wastewater to the advanced oxidation reactor (100A) and an oxidant supply portion (20) for supplying an oxidant to the advanced oxidation reactor (100A). Here, the oxidant may comprise peroxydisulfate (PDS). In addition, the semiconductor process wastewater treatment system may further include a pH adjustment portion (50) for adjusting the pH of the semiconductor process wastewater entering the anaerobic biological reactor (200) from the advanced oxidation reactor (100A).

The advanced oxidation reactor (100A) may include at least one ultraviolet light emitter (L1). The advanced oxidation reactor (100A) may include a wastewater movement path through which the semiconductor process wastewater and oxidant are moved. The semiconductor process wastewater and oxidizing agent passing through the wastewater movement path may be irradiated with ultraviolet light generated by the ultraviolet light emitter (L1). As a non-limiting example, two UV light emitters (L1) may be disposed on opposite sides of the wastewater movement path. The UV light emitter (L1) may include at least one UV-LED (light emitting diode) element, or may include a general UV light source other than an LED element. If the UV light emitter (L1) includes a UV-LED element, a plurality of UV-LED elements (chips) may be applied to one UV light emitter (L1). The ultraviolet light generated by the ultraviolet light emitter (L1) may be, for example, UV-C light. According to one example, the UV light emitter (L1) may be a UV-C lamp. The ultraviolet light generated by the ultraviolet light emitter (L1) may have a wavelength of, for example, about 250˜280 nm (e.g., 254 nm or 265 nm), but is not limited to those wavelengths.

In the advanced oxidation reactor (100A), the PDS may be activated with UV light. The activation of PDS by UV light may generate sulfate radicals. In addition, sulfate may be generated along with the sulfate radicals. In other words, sulfate radicals and sulfate may be generated by the UV/PDS process in the advanced oxidizing reactor (100A). The sulfate radicals may serve to highly oxidize TMAH. As sulfate radicals react with TMAH, TMAH may be converted to one or more intermediate molecule. TMAH may be converted to dimethylamine (DMA) via tetramethyl ammonium (TMA), DMA may be converted to monomethylamine (MMA), and MMA may be converted to NO₃⁻ and NH₄⁺. Thus, the intermediate may ultimately include NO₃⁻ and NH₄⁺. By the advanced oxidation process, TMAH may be degraded/removed and the toxicity associated with TMAH may be removed. In other words, the advanced oxidation process may degrade/remove strongly basic organics corresponding to TMAH. Thus, the stability of anaerobic microorganisms in a subsequent biological treatment process may be secured, such that the stability of a treatment process in the anaerobic biological reactor (200) may be secured.

In embodiments of the present disclosure, activation of persulfate (i.e., PDS) by UV may involve two mechanisms. The first is that the O—O bonds are cleaved by UV energy, such that 1 mole of persulfate may generate 2 moles of sulfate radicals (SO₄⁻*) (Equation 1 below). The second is that hydrogen atoms from water molecules (Equation 2 below) which may react with persulfate to produce sulfate radicals (SO₄⁻*) (Equation 3 below). The reaction in Equation 3 below may generate sulfate (SO₄²⁻). Persulfate may also be further converted to HO* under alkaline conditions through various activations. Thus, under acidic conditions, SO₄⁻* is the primary reaction, but under neutral conditions and above, both SO₄⁻* and HO* may contribute to the degradation of organic pollutants. On the other hand, Equation 4 below shows the formation of sulfate (SO₄²⁻) from persulfate (i.e. PDS). The persulfate ion is highly soluble in water and may be an oxidizing agent with a redox potential of about 2.01 V.

$${S}_{2} {O}_{8}^{2 -} {\to }^{UV} 2 {SO}_{4}^{- *} \qquad [ Equation 1 ]$$

$${H}_{2} O \to {H}^{*} + {HO}^{*} \qquad [ Equation 2 ]$$

$${S}_{2} {O}_{8}^{2 -} + {H}^{*} \to {SO}_{4}^{- *} + {SO}_{4}^{2 -} + {H}^{+} \qquad [ Equation 3 ]$$

$${S}_{2} {O}_{8}^{2 -} + 2 {e}^{-} \to 2 {SO}_{4}^{2 -} \qquad [ Equation 4 ]$$

The anaerobic biological reactor (200) may be configured to treat the semiconductor process wastewater that has passed through the advanced oxidation reactor (100A) with microorganisms including sulfate reducing bacteria (SRB) under anaerobic conditions. Anaerobic biological reactor (200) may be configured to react sulfate generated in advanced oxidation reactor (100A) with the sulfate reducing bacteria (SRB) to generate H₂S. The anaerobic biological reactor (200) may include an anaerobic sludge (210) therein, and microorganisms including sulfate reducing bacteria (SRB) may be present within the sludge (210). Since the microorganisms may be sensitive to oxygen, the microorganisms may be introduced into the anaerobic biological reactor (200) after oxygen is removed from the anaerobic biological reactor (200). Additionally, oxygen may be removed from the wastewater before introducing it to the anaerobic biological reactor (200). In this case, the oxygen may be removed from the wastewater such that the oxygen concentration is about 0.22 mg/L or less before being introduced into the anaerobic biological reactor (200). In addition, the pH in the biological reactor (200) may be adjusted to neutral or similar levels before the biological treatment process is performed. After adjusting the pH of the wastewater to neutral or a similar pH, the wastewater may be introduced into the anaerobic biological reactor (200). The anaerobic biological reactor (200) may further include a separator (220). The separator (220) may be disposed inside or outside of the anaerobic bioreactor (200), and may act as a settling tank or clarifier of sorts. A predetermined solution may be collected within the separator (220), from which the solution may be discharged (e.g., spilled). In addition, anaerobic sludge (210) may include organic matter, and the organic matter may, by way of non-limiting example, include butyrate, propionate, acetate, formate, and the like.

In one example, the anaerobic biological reactor (200) may include an anaerobic membrane bioreactor (AnMBR). Since the anaerobic biological reactor (200) utilizes sulfate reducing bacteria (SRB), the anaerobic biological reactor (200) may be an SRB-AnMBR. AnMBR is a technology that combines an anerobic biological treatment process and a separation membrane process, and has the advantage of being able to operate with a higher concentration of sludge in a lower reactor by applying a separation membrane process inside or outside the reactor to replace the settling tank in a conventional biological treatment process.

In an embodiment of the present disclosure, sulfate reducing bacteria (SRB) in the anaerobic sludge (210) may be utilized to react sulfate SO₄²⁻ generated in the UV/PDS with sulfate reducing bacteria (SRB) to generate H₂S, which may be collected by the gas separator (300) for utilization in the semiconductor industry or another industry. The gases generated in the anaerobic biological reactor (200) may include at least H₂S and CO₂, and the H₂S may be separated from these gases using the gas separator (300). The gas separator (300) may be, for example, a gas separation membrane. The gas separator (300) may be disposed at the top of the anaerobic biological reactor (200) to facilitate the separation and collect of H₂S. The collection of H₂S may result in improved economic benefits from resource recycling.

An ammonia collector (400) may be provided for collecting ammonia (NH₃) from the effluent discharged from the anaerobic biological reactor (200). The end product of TMAH after the process in the anaerobic biological reactor (200) may include NH₄⁺, NO₃⁻, NO₂, and the like. Here, NH₄⁺ is an ammonium ion. The effluent may include at least H₂O, NH₄⁺, NO₃⁻, and NO₂. Alternatively, the effluent may include at least H₂O, NH₄⁺, NO₃⁻, NO₂, and SO₄²⁻. The effluent may include an ionic substance such as NH₄⁺ or SO₄²⁻. Here, SO₄²⁻ may be residual SO₄²⁻.

The ammonia collector (400) may be configured to collect ammonia using one or more of a variety of processes, including stripping, ion exchange, membrane distillation (MD), and isothermal membrane distillation (IMD). The end products of TMAH, NH₄⁺, NO₃⁻, and NO₂, may be collected after conversion to ammonia by one or more of the following processes: stripping, ion exchange, MD, or IMD. Since the effluent from the anaerobic biological reactor 200 may contain large amounts of ammonium ions, ammonia collection may provide an economic benefit in terms of resource recycling.

According to one embodiment, the pH of the semiconductor process wastewater entering the advanced oxidation reactor (100A) may be in the range of, for example, about 11˜13. Accordingly, the initial semiconductor process wastewater may be strongly basic. When peroxydisulfate (PDS) is used in embodiments of the present disclosure, it may be desirable for the pH of the semiconductor process wastewater to be in the range of about 11˜13 (e.g., about 12) to increase efficiency in the UV/PDS process. However, the pH range of the semiconductor process wastewater input to the advanced oxidation reactor (100A) is not limited to the foregoing pH values and may vary in different embodiments.

In one aspect, the pH of the semiconductor process wastewater entering the anaerobic biological reactor (200) may be in the range of about 6˜8, for example. The semiconductor process wastewater that passes through the advanced oxidizing reactor (100A) and enters the anaerobic biological reactor (200) may have a pH in the range of about 6˜8 (e.g., about 7). In the anaerobic biological reactor (200), when the pH of the wastewater is in the range of about 6˜8, the biological treatment process may be performed without killing excessive levels of microbes within the reactor due to the pH level. In this regard, a pH adjustment section (50) may be provided for adjusting the pH of the semiconductor process wastewater entering the anaerobic biological reactor (200). A suitable pH adjustment material may be introduced into the pH adjustment section (50). However, the pH range of the semiconductor process wastewater input to the anaerobic biological reactor (200) is not limited to the foregoing range and may vary in different embodiments.

According to an embodiment of the present disclosure, a technology may be provided for the treatment of industrial wastewater containing a high concentration of TMAH generated in a semiconductor manufacturing process, which may secure the stability of the biological treatment process, increase the treatment efficiency, increase the economic efficiency, and reduce the environmental burden. First, by pretreating TMAH by applying an advanced oxidation process (AOP) using a UV/PDS process, TMAH may be converted into intermediates and toxicity may be reduced or removed, thereby securing the stability of anaerobic microorganisms in the subsequent biological treatment process. Thus, stable biological treatment is possible, efficiency may be increased, and treatment costs may be reduced. In addition, by collecting H₂S from the exhaust gas and ammonia from the effluent, the economic efficiency may be further improved through resource collecting and recycling.

In the case of conventional methods, the high toxicity of TMAH causes problems with toxic microbial killing in biological process operations. In addition, when the advanced oxidation process is used alone, a large amount of chemicals are required, which reduces economic efficiency and increases environmental burden. According to an embodiment of the present disclosure, by applying a predetermined advanced oxidation process in the front and a predetermined anaerobic biological treatment process in the back, the effects of securing stability, collecting/recycling resources, reducing wastewater treatment costs, and reducing environmental impact may be achieved by properly linking and fusing (mixing) the two processes. In an embodiment of the present disclosure, it is possible to apply the biological process after securing biological stability through an advanced oxidation process in the first step, and to process TMAH in a continuous process without separating strains. In addition, in an embodiment of the present disclosure, an anaerobic biological process (digestion process) may be applied after the UV/PDS process to remove toxic TMAH before performing the biological process. The system according to an embodiment of the present disclosure may be considered a hybridized system of a highly oxidizing process and an anaerobic biological process.

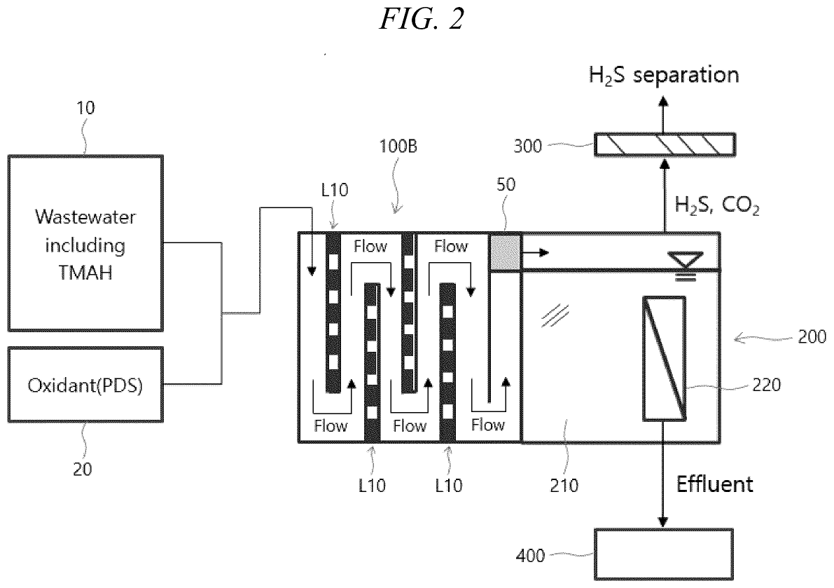

FIG. 2 is a diagram schematically illustrating a semiconductor process wastewater treatment system according to another embodiment of the present disclosure.

Referring to FIG. 2, a semiconductor process wastewater treatment system according to this embodiment may differ from the embodiment of FIG. 1 in the configuration of the advanced oxidation reactor (100B). In FIG. 2, except for the configuration of the advanced oxidation reactor (100B), the remaining configuration may be the same or substantially similar to the embodiment of FIG. 1. The embodiment of FIG. 2 will be described with emphasis on the configuration of the advanced oxidation reactor (100B).

The advanced oxidation reactor 100B may include a plurality of ultraviolet light emitters (L10). Each of the plurality of ultraviolet light emitters (L10) may include, for example, a UV-LED device (chip). Each of the plurality of ultraviolet light emitters (L10) may comprise a plurality of UV-LED elements. The ultraviolet light generated by the ultraviolet light emitter (L10) may be, for example, UV-C light. In one example, the UV light emitter (L10) may be a UV-LED lamp that generates UV-C light. The ultraviolet light generated by the ultraviolet light emitter (L10) may have a wavelength of, for example, about 250˜280 nm (e.g., 254 nm or 265 nm), but embodiments are not limited to those wavelengths.

The plurality of ultraviolet light emitters (L10) may be arranged to provide a winding wastewater transportation path with a plurality of bends. Thus, the semiconductor process wastewater may travel along the winding wastewater travel path. Accordingly, the winding wastewater travel path may be oriented vertically so that the wastewater flows up and down channels of the path, or oriented horizontally so that wastewater flows from side to side along the travel path. In this way, the use of the plurality of UV light emitters (L10) may significantly increase the process efficiency by maximizing the residence time of the wastewater in the advanced oxidation reactor (100B), unlike a UV-C lamp that provides a straight wastewater movement path. In particular, by utilizing a plurality of UV-LED elements (chips), a tortuous wastewater movement path may be more easily realized.

In FIG. 2, the configuration of the advanced oxidation reactor (100B) may be a side cross-sectional view or a plan view. The plurality of ultraviolet light emitters (L10) may be disposed on side surfaces, e.g., an upper surface and a lower surface, in the interior of the advanced oxidation reactor (100B). A first group of ultraviolet light emitters (L10) may be disposed on an inner upper surface of the advanced oxidation reactor (100B), and a second group of ultraviolet light emitters (L10) may be disposed on an inner lower surface of the advanced oxidation reactor (100B), and the ultraviolet light emitters (L10) of the first group and the ultraviolet light emitters (L10) of the second group may be alternately disposed from one end to the other end of the advanced oxidation reactor (100B). Alternatively, the plurality of ultraviolet light emitters (L10) may be disposed on a first inner surface and a second inner surface facing each other in the interior of the advanced oxidation reactor 100B.

More generally, a first group of ultraviolet light emitters (L10) may be disposed on a first inner surface of the advanced oxidation reactor (100B), and a second group of ultraviolet light emitters (L10) may be disposed on a second inner surface of the advanced oxidation reactor (100B). The ultraviolet light emitters (L10) of the first group and the ultraviolet light emitters (L10) of the second group may be disposed alternately from one end of the advanced oxidation reactor (100B) to the other end of the advanced oxidation reactor (100B). However, the specific configuration of the advanced oxidation reactor (100B) is not limited to the foregoing embodiments, and may vary in different embodiments. Furthermore, the arrangement relationship of the advanced oxidation reactor (100B), the anaerobic biological reactor (200), and the pH control unit (50) in FIG. 2 is only exemplary, and the arrangement relationship, location, connection relationship, etc. thereof may be varied in other embodiments.

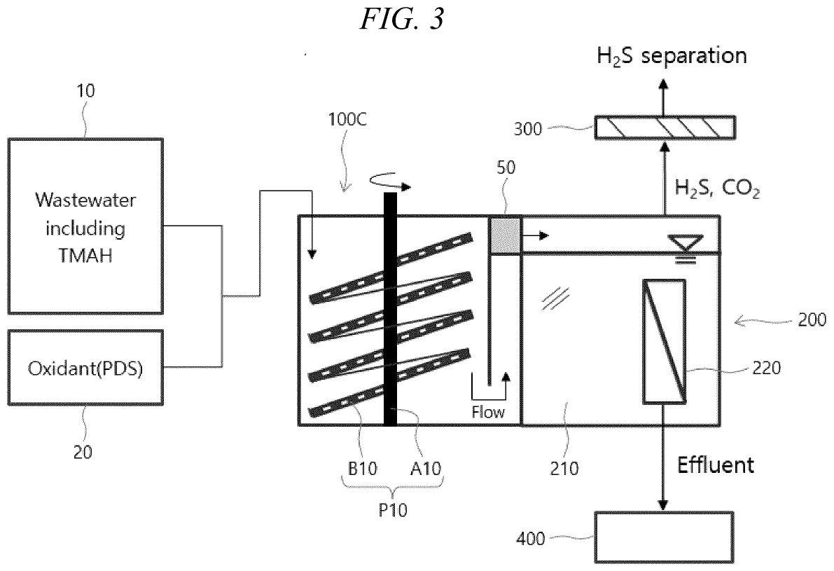

FIG. 3 is a diagram schematically illustrating a semiconductor process wastewater treatment system according to another embodiment of the present disclosure.

Referring to FIG. 3, a semiconductor process wastewater treatment system according to this embodiment may differ from the embodiment of FIG. 1 in the configuration of the advanced oxidation reactor (100C). In FIG. 3, except for the configuration of the advanced oxidation reactor (100C), the remaining configuration may be the same or substantially similar to the embodiment of FIG. 1. The embodiment of FIG. 3 will be described with emphasis on the configuration of the advanced oxidation reactor (100C).

The advanced oxidation reactor (100C) may include an impeller structure (P10). The impeller structure (P10) may include a rotating shaft member (A10) and a spiral blade member (B10) having a helical structure and coupled to the rotating shaft member (A10). The spiral blade member (B10) may have a continuous structure extending in a spiral shape. The spiral blade member (B10) may be a helical impeller, for example. A UV-LED device (chip) may be coupled the spiral blade member (B10). For example, one or more UV-LED device may be attached to an exterior surface of the spiral blade member (B10), or installed inside the spiral blade member, e.g., within a recess that is sealed by a cover that is transparent to the UV light emitted by the UV-LED device. A plurality of UV-LED elements may be installed on the inner or outer surfaces of the spiral blade member (B10). The ultraviolet light generated by the UV-LED elements may be, for example, UV-C light. In one example, the UV-LED elements may be LED lamps that generate UV-C light. The ultraviolet light generated by the UV-LED device may have a wavelength of, for example, about 250˜280 nm (e.g., 254 nm or 265 nm), but is not limited to those wavelengths.

The impeller structure (P10) may provide a tortuous wastewater movement path, and may irradiate UV light to a solution containing wastewater while rotating. Unlike a reactor with a straight UV-C lamp, the spiral blade member (B10) may be arranged inside the reactor (100C) to achieve the effect of maximizing the residence time of the wastewater and increasing the process efficiency through agitation. In particular, by using the spiral blade member (B10), vortices may be generated to improve the flow and mixing characteristics of the wastewater. Furthermore, a UV-LED element in the form of a chip may be placed on one or both of inner or outer surfaces of the spiral blade member (B10) to maximize the number of lamps relative to the capacity of the reaction tank (100C), and consequently, the efficiency of the advanced oxidation process may be maximized.

In FIG. 3, the arrangement relationships of the highly oxidizing reactor (100C), the anaerobic biological reactor (200), and the pH control section (50) are only exemplary, and their arrangement relationships, locations, connections, etc. may vary in other embodiments.

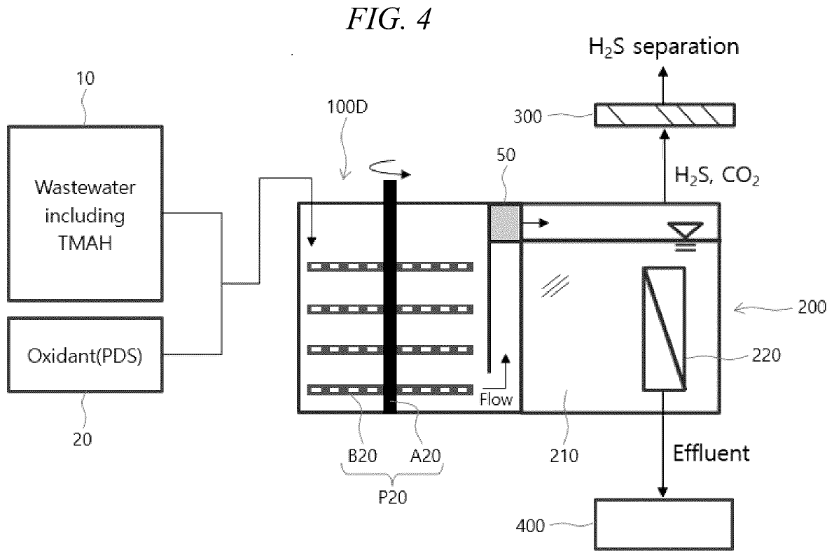

FIG. 4 is a diagram schematically illustrating a semiconductor process wastewater treatment system according to another embodiment of the present disclosure.

Referring to FIG. 4, a semiconductor process wastewater treatment system according to this embodiment may differ from the embodiment of FIG. 1 in the configuration of the advanced oxidation reactor (100D). With the exception of the configuration of the advanced oxidation reactor (100D) in FIG. 4, the configuration of the advanced oxidation reactor (100D) may be the same or substantially similar to the embodiment of FIG. 1. The embodiment of FIG. 4 will now be described, focusing on the configuration of the advanced oxidation reactor (100D).

The advanced oxidation reactor (100D) may comprise an impeller structure (P20). The impeller structure (P20) may include a rotating shaft member (A20) and a plurality of blade members (B20) coupled to the rotating shaft member (A20) and spaced apart from each other along a longitudinal direction of the rotating shaft member (A20). Each of the plurality of blade members (B20) may have the shape of a propeller blade. A UV-LED element (chip) may be installed on one or both of an inner and outer surface (e.g., an outer edge surface) of each of the plurality of blade members B20. The ultraviolet light generated by the UV-LED elements may be, for example, UV-C light. In one example, the UV-LED device may be an LED lamp that generates UV-C light. The ultraviolet light generated by the UV-LED device may have a wavelength of, for example, about 250˜280 nm (e.g., 254 nm or 265 nm), but is not limited to those wavelengths.

The impeller structure (P20) may provide a serpentine or similarly shaped wastewater movement path, and may function as an ultraviolet irradiation member that rotates to irradiate UV light to a solution comprising wastewater. The effect of the application of the impeller structure (P20) may be similar to that of the embodiment of FIG. 3 described above.

In FIG. 4, the arrangement relationships of the highly oxidizing reactor (100D), the anaerobic biological reactor (200), and the pH control portion (50) are exemplary, and their arrangement relationships, locations, connections, and the like may be varied in other embodiments.

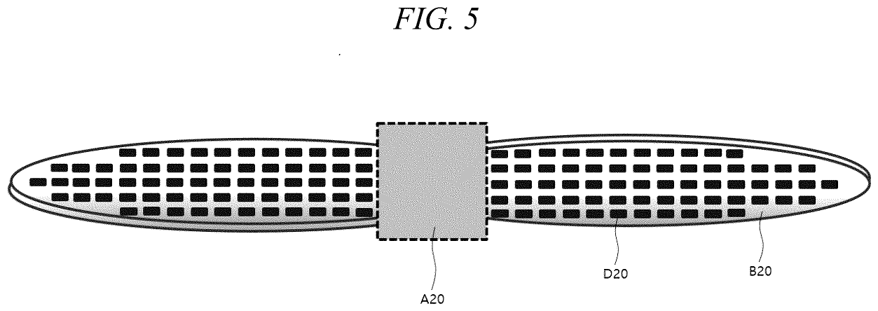

FIG. 5 is a drawing illustrating a specific configuration of an impeller structure that may be used in the embodiment of FIG. 4.

Referring to FIG. 5, an impeller structure may include a rotating shaft member (A20) and a blade member (B20) coupled to the rotating shaft member (A20). A pair of blade members (B20) may be disposed at the same level (e.g., height) of the shaft (A20), or three or more blade members (B20) may be disposed at the same level of the shaft. The pair of blade members (B20) or the three or more blade members (B20) may be considered as one ‘blade unit’. A plurality of UV-LED elements (D20) may be installed on the interior or exterior (outer surface) of the blade members B20. When the UV-LED elements (D20) are disposed on the interior of the blade member B20, the blade member B20 may include a light-transmissive material that allows the UV light from the UV-LED elements (D20) to pass. However, the configuration of the impeller structure described with reference to FIG. 5 is only exemplary, and the configuration may be varied in different embodiments. The UV-LED element (D20) installed on the blade member (B20) described in FIG. 5 may be applied to the spiral blade member (B10) of FIG. 3 in the same or similar manner.

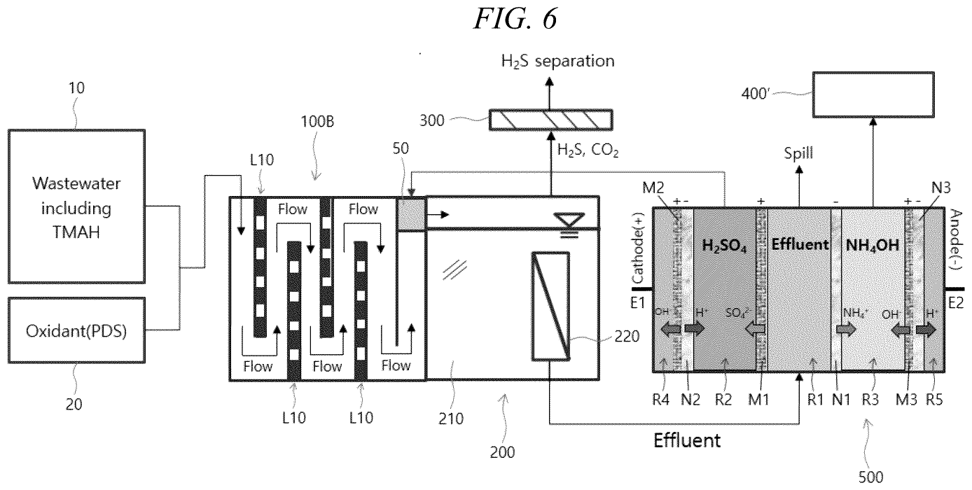

FIG. 6 is a diagram schematically illustrating a semiconductor process wastewater treatment system according to another embodiment of the present disclosure.

Referring now to FIG. 6, the semiconductor process wastewater treatment system according to an embodiment may be the system of FIG. 2 with the addition of a bipolar electrodialysis device, and in particular, a bipolar electrodialysis (BPED) device (500). The semiconductor process wastewater treatment system may further comprise a BPED device (500) for separating ions from effluent discharged from the anaerobic biological reactor (200). The effluent may comprise at least H₂O, NH₄⁺, NO₃⁻, NO₂, SO₄²⁻. The effluent may include ionic substances such as NH₄⁺, SO₄²⁻ and the like. The BPED device (500) may be configured to separate the ionic substances from the effluent to produce a predetermined substance. For example, the BPED device (500) may be configured to generate at least one of H₂SO₄ and NH₄OH from the effluent. The BPED device (500) may be configured to generate both H₂SO₄ and NH₄OH. The semiconductor process wastewater treatment system may be configured to feed at least a portion of the H₂SO₄ generated by the BPED unit (500) to the pH adjustment section (50). At least a portion of the H₂SO₄ may be input to the pH adjustment section 50 as a pH adjustment agent. The NH₄OH may be reusable depending on its purity, or alternatively, may be applied to ammonia collection.

According to one embodiment, the BPED device (500) may include a first region (R1), a second region (R2), a third region (R3), a fourth region (R4), and a fifth region R5. The first region (R1) may be disposed between the second region (R2) and the third region (R3), the second region (R2) may be disposed between the first region (R1) and the fourth region (R4), and the third region (R3) may be disposed between the first region (R1) and the fifth region (R5). Between the fourth region (R4) and the fifth region (R5), the second region (R2), the first region (R1) and the third region (R3) may be disposed in order from the fourth region (R4) side.

A first cation separator (M1) may be disposed between the first region (R1) and the second region (R2). A first anionic separator (N1) may be disposed between the first region (R1) and the third region (R3). A second anion separator (N2) and a second cation separator (M2) may be disposed between the second region (R2) and the fourth region (R4). The second cation separator (M2) may be disposed between the second anion separator (N2) and the fourth region (R4). A third cation separator (M3) and a third anion separator (N3) may be disposed between the third region (R3) and the fifth region (R5). The third cation separator (M3) may be disposed between the third anion separator (N3) and the fifth region (R5).

The runoff may be supplied to the first region (R1). Water may be present in the fourth region (R4) and the fifth region (R5). Further, the BPED device (500) may include an anode (E1) electrically connected to the fourth region (R4) and a cathode (E2) electrically connected to the fifth region (R5). Electrical energy may be applied to the anode (E1) and the cathode (E2).

According to one embodiment, the H₂SO₄ may be generated in the second region (R2), and the NH₄OH may be generated in the third region (R3). From the first region (R1), SO₄²⁻ may be provided to the second region (R2) through the first cation separator (M1), and from the fourth region (R4), H⁺ may be provided to the second region (R2) through the second cation separator (M2) and the second anion separator (N2), and H₂SO₄ may be generated in the second region (R2). From the first region (R1), NH₄⁺ may be provided to the third region (R3) through the first anion separator (N1), and from the fifth region (R5), OH⁻ may be provided to the third region (R3) through the third anion separator (N3) and the third cation separator (M3), and NH₄OH may be generated in the third region (R3).

The second region (R2) may be connected to the pH adjustment portion (50), and at least a portion of the H₂SO₄ generated in the second region (R2) may be fed to the pH adjustment portion (50). The NH₄OH generated in the third region (R3) may be reused depending on its purity, or alternatively, it may be applied to ammonia collection. In the latter case, the third region (R3) may be connected to an ammonia collector (400′). The ammonia collector (400′) may generate/collect ammonia (NH₃) from NH₄OH. The ammonia collector (400′) may be connected to the BPED unit (500). The BPED unit (500) may be disposed between the anaerobic biological reactor (200) and the ammonia collector (400′).

According to the present embodiment, resource collecting and recycling characteristics may be further enhanced by using the BPED device (500). However, the specific configuration and functionality of the BPED device (500) is not limited to the foregoing description, and may vary in different embodiments.

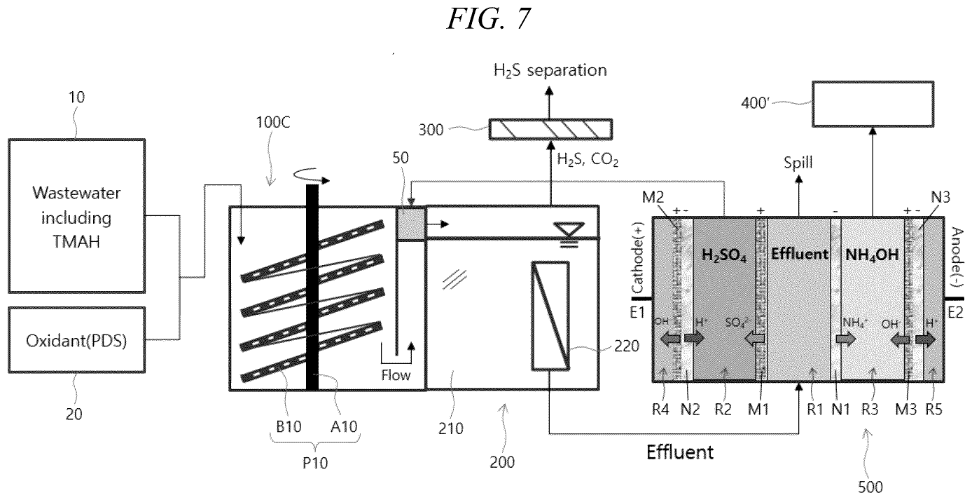

FIG. 7 is a diagram schematically illustrating a semiconductor process wastewater treatment system according to another embodiment of the present disclosure. The semiconductor process wastewater treatment system of FIG. 7 corresponds to the system of FIG. 3 with the BPED device (500) of FIG. 6 added. The BPED device (500) may also be applied to the systems of FIGS. 1 and 4.

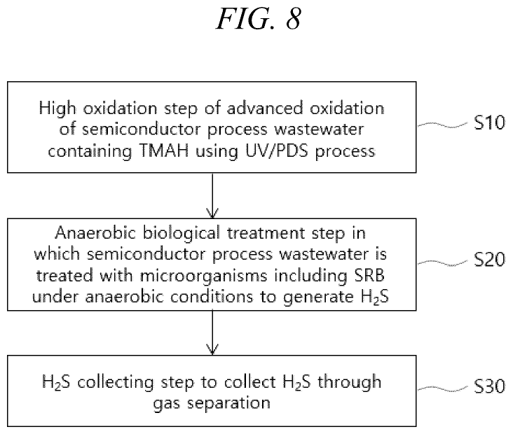

FIG. 8 is a flowchart illustrating a method for treating semiconductor process wastewater using a semiconductor process wastewater treatment system according to one embodiment of the present disclosure.

Referring to FIG. 8, a method for treating semiconductor process wastewater according to an embodiment of the present disclosure comprises: a highly oxidizing step (S10) in which the semiconductor process wastewater comprising TMAH is highly oxidized using a UV/PDS process, an anaerobic biological treatment step (S20) in which the semiconductor process wastewater subjected to the advanced oxidation step is treated with microorganisms including sulfate reducing bacteria (SRB) under anaerobic conditions to generate H₂S, and an H₂S collection step (S30) in which H₂S is collected by gas separation from gas generated in the anaerobic biological treatment step. In addition, the semiconductor process wastewater treatment method may further comprise an ammonia collection step for collecting ammonia from the effluent discharged from the anaerobic biological reactor used in the anaerobic biological treatment step. Any of the configurations and features described with reference to FIGS. 1 to 5 may be used to perform the semiconductor process wastewater treatment method according to embodiments of the present disclosure.

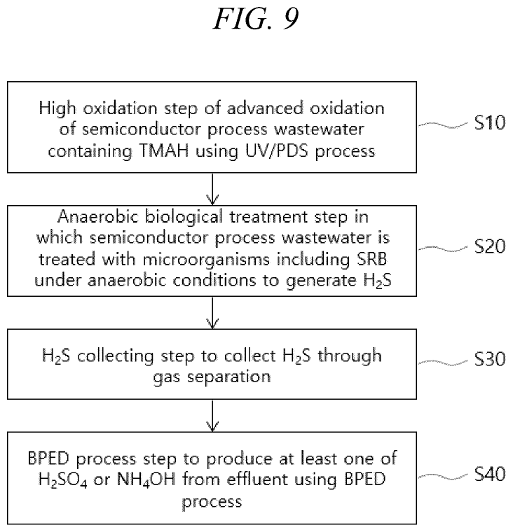

FIG. 9 is a flowchart to illustrating method for treating semiconductor process wastewater using a semiconductor process wastewater treatment system according to another embodiment of the present disclosure.

Referring to FIG. 9, a method for treating semiconductor process wastewater according to an embodiment may include steps (S10), (S20), and (S30) described in FIG. 8, and may further include a BPED process step (S40) in which a bipolar electrodialysis (BPED) process is applied to effluent discharged from an anaerobic biological reactor used in the anaerobic biological treatment step. In the BPED process step (S40), at least one of, for example, H₂SO₄ and NH₄OH may be generated. Further, the semiconductor process wastewater treatment method may further comprise an ammonia collection step to collect ammonia after step (S40). The semiconductor process wastewater treatment method according to the present embodiment may use the same configurations and features described with reference to FIGS. 1 to 7.

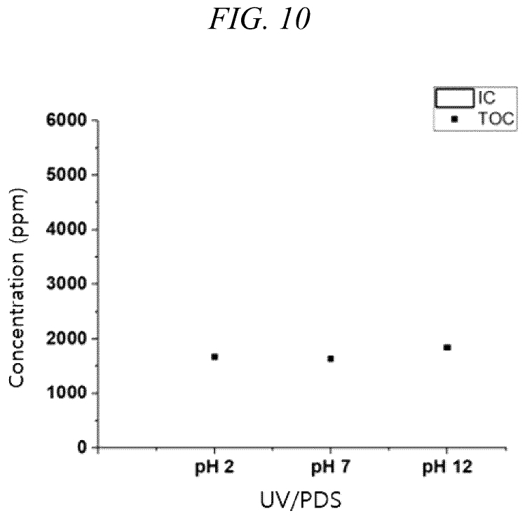

FIG. 10 is a graph showing the results of treating wastewater containing TMAH using an advanced oxidation process that may be applied to a semiconductor process wastewater treatment system according to an embodiment of the present disclosure. The advanced oxidation process was a UV/PDS process, wherein PDS was 600 mM, the wastewater including TMAH was diluted 10-fold, and the irradiation time of UV-C light was 4 hours. The pH of the wastewater was adjusted to 2, 7, and 12, and experiments were conducted in each case. In FIG. 10, TOC indicates the concentration of total organic carbon in the wastewater after the above-mentioned advanced oxidation process, and IC indicates the concentration of TMAH in the wastewater after the above-mentioned advanced oxidation process.

Referring to FIG. 10, it may be seen that when the UV/PDS process using sulfate radical was performed on wastewater containing TMAH, all of the TMAH was oxidized and no IC concentration was measured. Therefore, if a biological treatment process is applied after a highly oxidizing process, the stability of the biological treatment process may be ensured.

According to the embodiments of the present disclosure described above, a semiconductor process wastewater treatment system and a method for treating semiconductor process wastewater using the system may be realized that may secure process stability and increase treatment efficiency (process efficiency) in the treatment of semiconductor process wastewater containing recalcitrant organics such as TMAH. In addition, according to embodiments of the present disclosure, a semiconductor process wastewater treatment system and a semiconductor process wastewater treatment method using the system may be implemented that may reduce treatment costs in the treatment of semiconductor process wastewater containing recalcitrant organics such as TMAH, as well as improve economic efficiency and reduce environmental impact/burden through resource collecting and recycling.

According to one embodiment, by applying an advanced oxidation process and an anaerobic biological process in combination, the stability of the wastewater treatment process may be easily secured at a relatively low cost. In addition, according to one embodiment, by applying advanced oxidation prior to the anaerobic biological process, using a UV/PDS process that activates peroxydisulfate (PDS) with ultraviolet light (UV ray), the stability of the biological process may be significantly improved and cost savings may be achieved. In addition, in one embodiment, the anaerobic biological process utilizes sulfate reducing bacteria (SRB) to generate H₂S and collect it through gas separation, while collecting/recycling ammonia or other resource materials, thereby increasing economic efficiency and reducing environmental impact/burden. In addition, according to one embodiment, the efficiency of the advanced oxidation process may be significantly increased through the technology of the advanced oxidation reaction tank, and the recyclability of resources may be further improved through bipolar electrodialysis.

This description discloses embodiments of the present disclosure, and although certain terms are used, they are used in a general sense only to facilitate the description and understanding of the disclosure and are not intended to limit the scope of the disclosure. In addition to the embodiments disclosed herein, other modifications based on the technical ideas of the present disclosure will be apparent to those of ordinary skill in the art to which the present disclosure belongs. It will be apparent to those having ordinary knowledge in the art that the semiconductor process wastewater treatment system using an advanced oxidation process and an anaerobic biological process according to the embodiments described with reference to FIGS. 1 to 10, and the method of treating semiconductor process wastewater using the same, may be subject to various substitutions, changes and modifications without departing from the technical ideas of the disclosure. The scope of the disclosure is therefore not to be defined by the embodiments described, but by the technical ideas recited in the patent claims.

What is claimed is:

1. A semiconductor process wastewater treatment system comprising:
an advanced oxidation reactor configured to oxidize semiconductor process wastewater comprising tetramethyl ammonium hydroxide (TMAH) using a UV/PDS process that activates peroxydisulfate (PDS) with ultraviolet (UV) rays;
an anaerobic biological reactor configured to biologically treat the semiconductor process wastewater that has passed through the advanced oxidation reactor with microorganisms comprising sulfate reducing bacteria (SRB) under anaerobic conditions, and configured to react sulfate generated in the advanced oxidation reactor with the sulfate reducing bacteria to generate H₂S; and
a gas separator configured to separate the H₂S from gas generated in the anaerobic biological reactor.

2. The system of claim 1, wherein the anaerobic biological reactor is an anaerobic membrane bioreactor (AnMBR).

3. The system of claim 1, further comprising:
an ammonia collector configured to collect ammonia from effluent discharged from the anaerobic biological reactor.

4. The system of claim 1, wherein the advanced oxidation reactor comprises a plurality of ultraviolet light emitters, and each of the plurality of ultraviolet light emitters comprises at least one UV-LED element, and
wherein the plurality of ultraviolet light emitters are arranged to provide a plurality of bends in a meandering wastewater travel path such that the semiconductor process wastewater flows along the meandering wastewater flow path.

5. The system of claim 1, wherein the advanced oxidation reactor includes an impeller structure comprising:
a rotating shaft member;
a helical blade member coupled to the rotating shaft member; and
a plurality of UV-LED elements coupled to the helical blade member.

6. The system of claim 1, wherein the advanced oxidation reactor includes an impeller structure comprising:
a rotating shaft member;
a plurality of blade members coupled to the rotating shaft member and mutually spaced apart along a longitudinal direction of the rotating shaft member; and
UV-LED elements coupled to the plurality of blade members.

7. The system of claim 1, further comprising:
a pH adjustment section configured to adjust the pH of the semiconductor process wastewater fed from the highly oxidizing reactor to the anaerobic biological reactor.

8. The system of claim 1, further comprising:
a bipolar electrodialysis (BPED) device configured to separate ions from effluent discharged from the anaerobic biological reactor.

9. The system of claim 1, wherein the BPED device is configured to produce at least one of H₂SO₄ and NH₄OH from the effluent.

10. The system of claim 9, further comprising:
a pH adjustment section configured to adjust the pH of the semiconductor process wastewater fed from the highly oxidizing reactor to the anaerobic biological reactor,
wherein the semiconductor process wastewater treatment system is configured to feed at least a portion of the H₂SO₄ generated by the BPED device to the pH adjustment unit.

11. The system of claim 9, wherein the BPED device comprises a first region, a second region, a third region, a fourth region, and a fifth region, the first region being disposed between the second region and the third region, the second region being disposed between the first region and the fourth region, and the third region being disposed between the first region and the fifth region,
wherein a first cationic separator is disposed between the first region and the second region,
wherein a first anion separator is disposed between the first region and the third region,
wherein a second anion separator and a second cation separator are disposed between the second region and the fourth region in series,
wherein a third cationic separator and a third anionic separator are disposed between the third region and the fifth region in series, and
wherein the H₂SO₄ is produced in the second region and the NH₄OH is produced in the third region.

12. The system of claim 8, further comprising:
an ammonia collector connected to the BPED unit.

13. The system of claim 1, wherein the semiconductor process wastewater input to the advanced oxidation reactor has a pH in the range of about 11 to 13.

14. The system of claim 1, wherein the semiconductor process wastewater input to the anaerobic biological reactor has a pH in the range of about 6 to 8.

15. A method for treating semiconductor process wastewater comprising tetramethyl ammonium hydroxide (TMAH) using the semiconductor process wastewater treatment system according to claim 1.
